(19) United States
(12) Patent Application Publication
(10) Pub. No.: US 2021/0357967 A1
(43) Pub. Date: Nov. 18, 2021

(54) COMPUTING SYSTEM FOR PROVIDING AND DISPLAYING DIGITAL COUPONS AND METHOD OF OPERATION THEREOF

(71) Applicant: Capital One Services, LLC, McLean, VA (US)

(72) Inventors: James ZARAKAS, Centreville, VA (US); Adam VUKICH, Alexandria, VA (US); Molly JOHNSON, Alexandria, VA (US)

(73) Assignee: Capital One Services, LLC, McLean, VA (US)

(21) Appl. No.: 16/876,999

(22) Filed: May 18, 2020

(51) Int. Cl. G06Q 30/02; H04W 4/021; H04W 4/02; G06F 16/951; G06F 16/29

(52) U.S. Cl. CPC G06Q 30/0224; H04W 4/021; G06F 16/29; G06F 16/951; H04W 4/027

(57) ABSTRACT

A system and method of operating a computing system including: a control unit configured to: generate a user transaction history based on parsing a user data set received from a transaction history database; generate a database of a collected coupon data based on the user transaction history; identify a merchant location based on a map data from a map database, and the database of the collected coupon data; identify a merchant based on a user location and the merchant location; retrieve the collected coupon data associated with the merchant based on identifying the merchant; activate the collected coupon data on a transaction card based on an activate parameter; and a storage unit, coupled to the control unit, configured to store the database of the collected coupon data and the merchant location for retrieval during an application state; and a communication unit, coupled to the control unit, configured to transmit the collected coupon data to the transaction card for display on a user interface.

### TECHNICAL FIELD

An embodiment of the present invention relates generally to a computing system, and more particularly to a computing system for providing and displaying digital coupons.

### BACKGROUND

Coupons are used by many individuals. The ability to obtain coupons from merchants, particularly those which an individual frequents on a regular basis, is of great value and a source of savings for many individuals. However, finding, obtaining, and using coupons are still burdensome for many individuals. Despite technological advancements, current technologies still lack the ability to detect targeted coupons for individuals and deliver them to the individual when the individual needs to use the coupon. Accordingly, there remains a need for improved techniques for detecting targeted coupons and delivering them to individuals.

In view of the ever-increasing commercial competitive pressures, along with growing consumer expectations and the diminishing opportunities for meaningful product differentiation in the marketplace, it is increasingly critical that answers be found to these problems. Additionally, the need to reduce costs, improve efficiencies and performance, and meet competitive pressures adds an even greater urgency to the critical necessity for finding answers to these problems.

Solutions to these problems have been long sought but prior developments have not taught or suggested any solutions and, thus, solutions to these problems have long eluded those skilled in the art.

### SUMMARY

An embodiment of the present invention provides a method of operating a computing system including: generating a user transaction history based on parsing a user data set received from a transaction history database; generating a database of a collected coupon data based on the user transaction history; identifying a merchant location based on a map data from a map database, and the database of the collected coupon data; storing, in a storage unit, the database of the collected coupon data and the merchant location for retrieval during an application state; identifying, in the application state, a merchant based on a user location and the merchant location; retrieving, from the storage unit, the collected coupon data associated with the merchant based on identifying the merchant; transmitting the collected coupon data to a transaction card for display on a user interface; and activating the collected coupon data on the transaction card based on an activate parameter.

An embodiment of the present invention provides a computing system including: a control unit configured to: generate a user transaction history based on parsing a user data set received from a transaction history database; generate a database of a collected coupon data based on the user transaction history; identify a merchant location based on a map data from a map database, and the database of the collected coupon data; identify a merchant based on a user location and the merchant location; retrieve the collected coupon data associated with the merchant based on identifying the merchant; activate the collected coupon data on a transaction card based on an activate parameter; and a storage unit, coupled to the control unit, configured to store the database of the collected coupon data and the merchant location for retrieval during an application state; and a communication unit, coupled to the control unit, configured to transmit the collected coupon data to the transaction card for display on a user interface.

An embodiment of the present invention provides a non-transitory computer readable medium including instructions for a computing system including: generating a user transaction history based on parsing a user data set received from a transaction history database; generating a database of a collected coupon data based on the user transaction history; identifying a merchant location based on a map data from a map database, and the database of the collected coupon data; storing the database of the collected coupon data and the merchant location for retrieval during an application state; identifying, in the application state, a merchant based on a user location and the merchant location; retrieving the collected coupon data associated with the merchant based on identifying the merchant; transmitting the collected coupon data to a transaction card for display on a user interface; and activating the collected coupon data on the transaction card based on an activate parameter.

Certain embodiments of the invention have other steps or elements in addition to or in place of those mentioned above. The steps or elements will become apparent to those skilled in the art from a reading of the following detailed description when taken with reference to the accompanying drawings.

### BRIEF DESCRIPTION OF THE DRAWINGS

FIG. 1 is a computing system for providing and displaying digital coupons, according to an embodiment of the present invention.

FIG. 2 is an example block diagram of the components of the computing system, according to an embodiment of the present invention.

FIG. 3 is a further example block diagram of the components of the computing system, according to an embodiment of the present invention.

FIG. 4 is an example control flow of operating stages of the computing system, according to an embodiment of the present invention.

FIG. 5 is an example control flow of a crawling state of the computing system, according to an embodiment of the present invention.

FIG. 6 is an example control flow of an application state of the computing system, according to an embodiment of the present invention.

FIG. 7 is an example method of operating the computing system, according to an embodiment of the present invention.

### DETAILED DESCRIPTION

The following embodiments are described in sufficient detail to enable those skilled in the art to make and use the invention. It is to be understood that other embodiments would be evident based on the present disclosure, and that system, process, or mechanical changes may be made without departing from the scope of an embodiment of the present invention.

In the following description, numerous specific details are given to provide a thorough understanding of embodiments of the invention. However, it will be apparent that embodiments of the invention may be practiced without these specific details. In order to avoid obscuring an embodiment of the present invention, some well-known circuits, system configurations, and process steps are not disclosed in detail.

The drawings showing embodiments of the system are semi-diagrammatic, and not to scale. Some of the dimensions are for the clarity of presentation and are shown exaggerated in the drawing figures. Similarly, although the views in the drawings are for ease of description and generally show similar orientations, this depiction in the figures is arbitrary for the most part. Generally, the invention can be operated in any orientation.

The term “module” or “unit” referred to herein can include software, hardware, or a combination thereof in an embodiment of the present invention in accordance with the context in which the term is used. For example, the software can be machine code, firmware, embedded code, or application software. Also for example, the hardware can be circuitry, a processor, a special purpose computer, an integrated circuit, integrated circuit cores, a pressure sensor, an inertial sensor, a microelectromechanical system (MEMS), passive devices, or a combination thereof. Further, if a module or unit is written in the system or apparatus claims section below, the module or unit is deemed to include hardware circuitry for the purposes and the scope of the system or apparatus claims.

The modules and units in the following description of the embodiments can be coupled to one another as described or as shown. The coupling can be direct or indirect, without or with intervening items between coupled modules or units. The coupling can be by physical contact or by communication between modules or units.

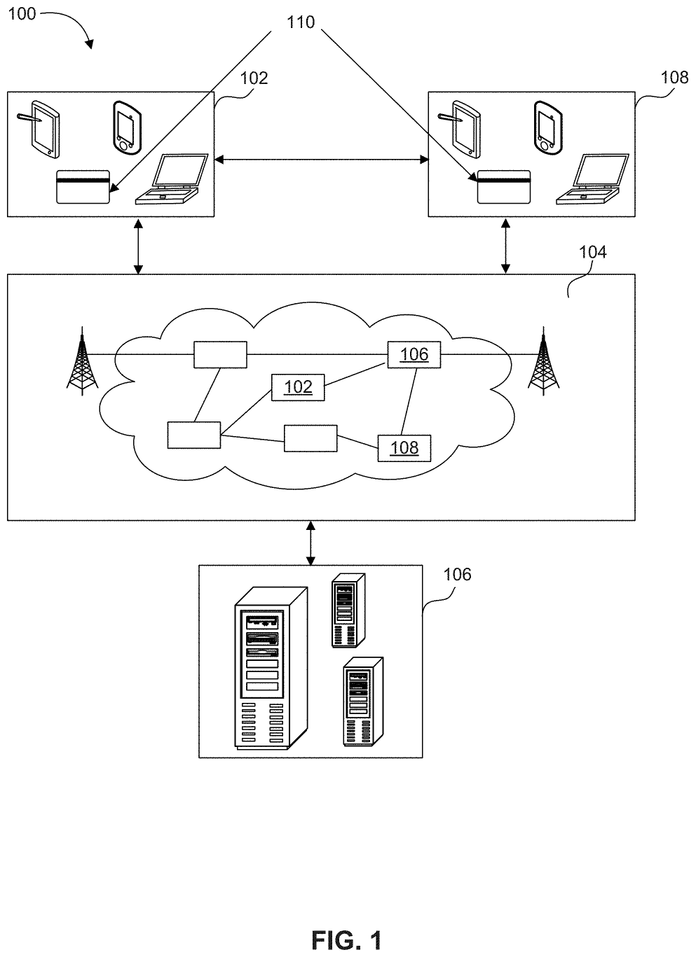

Referring now to FIG. 1, therein is shown a computing system 100 for providing and displaying digital coupons, according to an embodiment of the present invention. The computing system 100 includes a first device 102, such as a client device or a server, connected to a second device 106, such as a client device or server. The first device 102 can be further connected to a third device 108, such as a client device or a server. The second device 106 can be further connected to the third device 108. The first device 102, the second device 106, and the third device 108 can communicate with each other through a communication path 104, such as a wireless or wired network.

For example, the first device 102 and the third device 108 can be of any of a variety of devices, such as a smart phone, a cellular phone, a personal digital assistant, a tablet computer, a notebook computer, a laptop computer, a desktop computer, or a transaction card 110, such as a smart credit card, with various electronic components integrated that enable communication, sensor capabilities, and storage capabilities. The transaction card 110 has been described in U.S. patent application Ser. No. 16/279,465, the contents of which are incorporated by reference herein. The first device 102 and the third device 108 can be associated with a user of the computing system 100. The first device 102 and the third device 108 can couple, either directly or indirectly, to the communication path 104 to communicate with the second device 106 or can be stand-alone devices.

The second device 106 can be any of a variety of centralized or decentralized computing devices. For example, the second device 106 can be a laptop computer, a desktop computer, grid-computing resources, a virtualized computing resource, cloud computing resources, routers, switches, peer-to-peer distributed computing devices, a server, or a combination thereof. The second device 106 can be centralized in a single room, distributed across different rooms, distributed across different geographical locations, or embedded within a telecommunications network. The second device 106 can couple with the communication path 104 to communicate with the first device 102, the third device 108, or a combination thereof.

For illustrative purposes, the computing system 100 is shown with the first device 102 and the third device 108 as client devices, although it is understood that the computing system 100 can have the first device 102 or the third device 108 as a different type of device. For example, the first device 102 or the third device 108 can be a server. Also for illustrative purposes, the computing system 100 is shown with the second device 106 as a server, although it is understood that the computing system 100 can have the second device 106 as a different type of device. For example, the second device 106 can be a client device.

For brevity of description in the embodiments discussed below, the first device 102 and the third device 108 will be described as client devices and the second device 106 will be described as a server device. The embodiments of the present invention, however, are not limited to this selection for the type of devices. The selection is an example of an embodiment of the present invention.

Also for illustrative purposes, the computing system 100 is shown with the first device 102, the second device 106, and the third device 108 as end points of the communication path 104, although it is understood that the computing system 100 can have a different partition between the first device 102, the second device 106, the third device 108, and the communication path 104. For example, the first device 102, the second device 106, the third device 108, or a combination thereof can also function as part of the communication path 104.

The communication path 104 can span and represent a variety of networks and network topologies. For example, the communication path 104 can include wireless communication, wired communication, optical communication, ultrasonic communication, or a combination thereof. For example, satellite communication, cellular communication, Bluetooth, Infrared Data Association standard (IrDA), wireless fidelity (WiFi), and worldwide interoperability for microwave access (WiMAX) are examples of wireless communication that can be included in the communication path 104. Cable, Ethernet, digital subscriber line (DSL), fiber optic lines, fiber to the home (FTTH), and plain old telephone service (POTS) are examples of wired communication that can be included in the communication path 104. Further, the communication path 104 can traverse a number of network topologies and distances. For example, the communication path 104 can include direct connection, personal area network (PAN), local area network (LAN), metropolitan area network (MAN), wide area network (WAN), or a combination thereof.

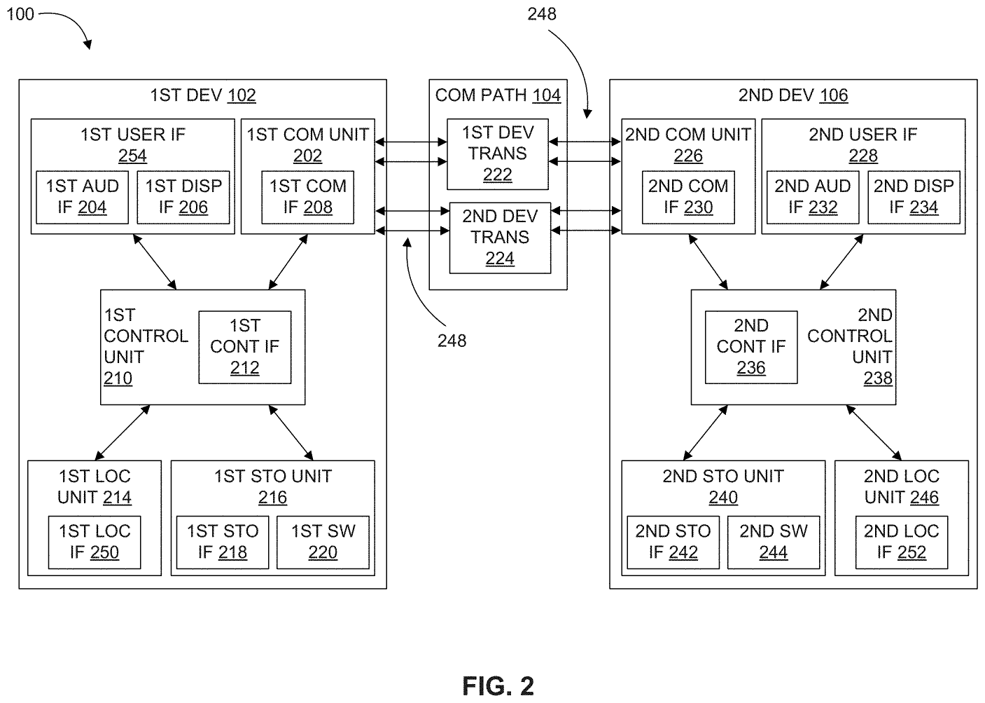

Referring now to FIG. 2, therein is shown an example block diagram of the components of the computing system 100, according to an embodiment of the present invention. The first device 102 can send information in a first device transmission 222 over the communication path 104 to the second device 106. The second device 106 can send information in a second device transmission 224 over the communication path 104 to the first device 102. The first device transmission 222 and the second device transmission 224 can be sent over one or more communication channels 248. A communication channel 248 refers either to a physical transmission medium such as a wire, or to a logical connection over a multiplexed medium such as a radio channel.

For illustrative purposes, the computing system 100 is shown with the first device 102 as a client device, although it is understood that the computing system 100 can have the first device 102 as a different type of device. For example, the first device 102 can be a server. Also for illustrative purposes, the computing system 100 is shown with the second device 106 as a server, although it is understood that the computing system 100 can have the second device 106 as a different type of device. For example, the second device 106 can be a client device.

For brevity of description in this embodiment of the present invention, the first device 102 will be described as a client device and the second device 106 will be described as a server device. Embodiments of the present invention are not limited to this selection for the type of devices. The selection is an example of an embodiment of the present invention.

The first device 102 can include a first control unit 210, a first storage unit 216, a first communication unit 202, a first user interface 254, and a first location unit 214. The first control unit 210 can include a first control interface 212. The first control unit 210 can execute a first software 220 to provide some or all of the intelligence of the computing system 100. The first control unit 210 can be implemented in a number of different ways. For example, the first control unit 210 can be a processor, an application specific integrated circuit (ASIC), an embedded processor, a microprocessor, a hardware control logic, a hardware finite state machine (FSM), a digital signal processor (DSP), a field programmable gate array (FPGA), or a combination thereof.

The first control interface 212 can be used for communication between the first control unit 210 and other functional units in the first device 102. The first control interface 212 can also be used for communication that is external to the first device 102. The first control interface 212 can receive information from the other functional units of the first device 102 or from external sources, or can transmit information to the other functional units of the first device 102 or to external destinations. The external sources and the external destinations refer to sources and destinations external to the first device 102. The first control interface 212 can be implemented in different ways and can include different implementations depending on which functional units or external units are being interfaced with the first control interface 212. For example, the first control interface 212 can be implemented with a pressure sensor, an inertial sensor, a microelectromechanical system (MEMS), optical circuitry, waveguides, wireless circuitry, wireline circuitry such as a bus, an application programming interface, or a combination thereof.

The first storage unit 216 can store the first software 220. For illustrative purposes, the first storage unit 216 is shown as a single element, although it is understood that the first storage unit 216 can be a distribution of storage elements. Also for illustrative purposes, the computing system 100 is shown with the first storage unit 216 as a single hierarchy storage system, although it is understood that the computing system 100 can have the first storage unit 216 in a different configuration. For example, the first storage unit 216 can be formed with different storage technologies forming a memory hierarchal system including different levels of caching, main memory, rotating media, or off-line storage. The first storage unit 216 can be a volatile memory, a nonvolatile memory, an internal memory, an external memory, or a combination thereof. For example, the first storage unit 216 can be a nonvolatile storage such as non-volatile random access memory (NVRAM), Flash memory, disk storage, or a volatile storage such as static random access memory (SRAM) or dynamic random access memory (DRAM).

The first storage unit 216 can include a first storage interface 218. The first storage interface 218 can be used for communication between the first storage unit 216 and other functional units in the first device 102. The first storage interface 218 can also be used for communication that is external to the first device 102. The first storage interface 218 can receive information from the other functional units of the first device 102 or from external sources, or can transmit information to the other functional units or to external destinations. The first storage interface 218 can include different implementations depending on which functional units or external units are being interfaced with the first storage unit 216. The first storage interface 218 can be implemented with technologies and techniques similar to the implementation of the first control interface 212.

The first communication unit 202 can enable external communication to and from the first device 102. For example, the first communication unit 202 can permit the first device 102 to communicate with the second device 106, the third device 108 of FIG. 1, an attachment, such as a peripheral device, and the communication path 104. The first communication unit 202 can also function as a communication hub allowing the first device 102 to function as part of the communication path 104 and not be limited to be an end point or terminal unit to the communication path 104. The first communication unit 202 can include active and passive components, such as microelectronics or an antenna, for interaction with the communication path 104.

The first communication unit 202 can include a first communication interface 208. The first communication interface 208 can be used for communication between the first communication unit 202 and other functional units of the first device 102. The first communication interface 208 can receive information from the other functional units of the first device 102 or from external sources, or can transmit information to the other functional units or to external destinations. The first communication interface 208 can include different implementations depending on which functional units are being interfaced with the first communication unit 202. The first communication interface 208 can be implemented with technologies and techniques similar to the implementation of the first control interface 212.

The first communication unit 202 can couple with the communication path 104 to send information to the second device 106 in the first device transmission 222. The second device 106 can receive information in a second communication unit 226 from the first device 102 in the first device transmission 222 through the communication path 104.

The first user interface 254 can present information generated by the computing system 100. In one embodiment, the first user interface 254 allows a user of the computing system 100 to interface with the first device 102. The first user interface 254 can include an input device and an output device. Examples of the input device of the first user interface 254 can include a keypad, buttons, switches, touchpads, soft-keys, a keyboard, a microphone, sensors for receiving remote signals, or any combination thereof to provide data and communication inputs. Examples of the output device can include a first display interface 206 and a first audio interface 204. The first control unit 210 can operate the first user interface 254 to present information generated by the computing system 100. The first control unit 210 can also execute the first software 220 to present information generated by the computing system 100, or to control other functional units of the computing system 100.

The first display interface 206 can be any graphical user interface such as a display, a projector, a video screen, or any combination thereof. The first audio interface 204 can include speakers, microphones, subwoofers, surround sound components, transducers, or any combination thereof. The first display interface 206 and the first audio interface 204 allow a user of the computing system 100 to interact with the computing system 100.

The first location unit 214 can generate location information, current heading, and current speed and acceleration of the first device 102, as examples. The first location unit 214 can be implemented in many ways. For example, the first location unit 214 can function as at least a part of a global positioning system (GPS) and can include components, such as a GPS receiver, an inertial navigation system, a cellular-tower location system, a pressure location system, an accelerometer, a gyroscope, or any combination thereof.

The first location unit 214 can include a first location interface 250. The first location interface 250 can be used for communication between the first location unit 214 and other functional units in the first device 102. The first location interface 250 can also be used for communication that is external to the first device 102. The first location interface 250 can be implemented with technologies and techniques similar to the implementation of the first control interface 212.

The second device 106 can be optimized for implementing an embodiment of the present invention in a multiple device embodiment with the first device 102 and the third device 108 of FIG. 1. In one embodiment, the second device 106 can provide additional or higher performance processing power compared to the first device 102, the third device 108, or a combination thereof. The second device 106 can include a second control unit 238, a second storage unit 240, a second communication unit 226, a second user interface 228, and a second location unit 246.

The second control unit 238 can include a second control interface 236. The second control unit 238 can execute a second software 244 to provide some or all of the intelligence of the computing system 100. The second software 244 can operate independently or in conjunction with the first software 220. In one embodiment, the second control unit 238 can provide additional performance compared to the first control unit 210. The second control unit 238 can be implemented in a number of different ways. For example, the second control unit 238 can be a processor, an application specific integrated circuit (ASIC), an embedded processor, a microprocessor, a hardware control logic, a hardware finite state machine (FSM), a digital signal processor (DSP), a field programmable gate array (FPGA), or a combination thereof.

The second control unit 238 can include a second control interface 236. The second control interface 236 can be used for communication between the second control unit 238 and other functional units of the second device 106. The second control interface 236 can also be used for communication that is external to the second device 106. The second control interface 236 can receive information from the other functional units of the second device 106 or from external sources, or can transmit information to the other functional units of the second device 106 or to external destinations. The external sources and the external destinations refer to sources and destinations external to the second device 106. The second control interface 236 can be implemented in different ways and can include different implementations depending on which functional units or external units are being interfaced with the second control interface 236. For example, the second control interface 236 can be implemented with a pressure sensor, an inertial sensor, a microelectromechanical system (MEMS), optical circuitry, waveguides, wireless circuitry, wireline circuitry such as a bus, an application programming interface, or a combination thereof.

The second storage unit 240 can store the second software 244. The second storage unit 240 can be sized to provide the additional storage capacity to supplement the first storage unit 216. For illustrative purposes, the second storage unit 240 is shown as a single element, although it is understood that the second storage unit 240 can be a distribution of storage elements. Also for illustrative purposes, the computing system 100 is shown with the second storage unit 240 as a single hierarchy storage system, although it is understood that the computing system 100 can have the second storage unit 240 in a different configuration. For example, the second storage unit 240 can be formed with different storage technologies forming a memory hierarchal system including different levels of caching, main memory, rotating media, or off-line storage. The second storage unit 240 can be a volatile memory, a nonvolatile memory, an internal memory, an external memory, or a combination thereof. For example, the second storage unit 240 can be a nonvolatile storage such as non-volatile random access memory (NVRAM), Flash memory, disk storage, or a volatile storage such as static random access memory (SRAM) or dynamic random access memory (DRAM).

The second storage unit 240 can include a second storage interface 242. The second storage interface 242 can be used for communication between the second storage unit 240 and other functional units of the second device 106. The second storage interface 242 can also be used for communication that is external to the second device 106. The second storage interface 242 can receive information from the other functional units of the second device 106 or from external sources, or can transmit information to the other functional units or to external destinations. The second storage interface 242 can include different implementations depending on which functional units or external units are being interfaced with the second storage unit 240. The second storage interface 242 can be implemented with technologies and techniques similar to the implementation of the second control interface 236.

The second communication unit 226 can enable external communication to and from the second device 106. For example, the second communication unit 226 can permit the second device 106 to communicate with the first device 102, the third device 108 of FIG. 1, an attachment, such as a peripheral device, and the communication path 104. The second communication unit 226 can also function as a communication hub allowing the second device 106 to function as part of the communication path 104 and not be limited to be an end point or terminal unit to the communication path 104. The second communication unit 226 can include active and passive components, such as microelectronics or an antenna, for interaction with the communication path 104.

The second communication unit 226 can couple with the communication path 104 to send information to the first device 102 in the second device transmission 224. The first device 102 can receive information in a first communication unit 202 from the second device 106 in the second device transmission 224 through the communication path 104.

The second communication unit 226 can include a second communication interface 230.

The second communication interface 230 can be used for communication between the second communication unit 226 and other functional units of the second device 106. The second communication interface 230 can receive information from the other functional units of the second device 106 or from external sources, or can transmit information to the other functional units or to external destinations. The second communication interface 230 can include different implementations depending on which functional units are being interfaced with the second communication unit 226. The second communication interface 230 can be implemented with technologies and techniques similar to the implementation of the second control interface 236.

The second user interface 228 can present information generated by the computing system 100. In one embodiment, the second user interface 228 allows a user of the computing system 100 to interface with the second device 106. The second user interface 228 can include an input device and an output device. Examples of the input device of the second user interface 228 can include a keypad, buttons, switches, touchpads, soft-keys, a keyboard, a microphone, sensors for receiving remote signals, or any combination thereof to provide data and communication inputs. Examples of the output device can include a second display interface 234 and a second audio interface 232. The second control unit 238 can operate the second user interface 228 to present information generated by the computing system 100. The second control unit 238 can also execute the second software 244 to present information generated by the computing system 100, or to control other functional units of the computing system 100.

The second display interface 234 can be any graphical user interface such as a display, a projector, a video screen, or any combination thereof. The second audio interface 232 can include speakers, microphones, subwoofers, surround sound components, transducers, or any combination thereof. The second display interface 234 and the second audio interface 232 allow a user of the computing system 100 to interact with the computing system 100.

The second location unit 246 can generate location information, current heading, and current speed and acceleration of the second device 106, as examples. The second location unit 246 can be implemented in many ways. For example, the second location unit 246 can function as at least a part of a global positioning system (GPS) and can include components, such as a GPS receiver, an inertial navigation system, a cellular-tower location system, a pressure location system, an accelerometer, a gyroscope, or any combination thereof.

The second location unit 246 can include a second location interface 252. The second location interface 252 can be used for communication between the second location unit 246 and other functional units of the second device 106. The second location interface 252 can also be used for communication that is external to the second device 106. The second location interface 252 can be implemented with technologies and techniques similar to the implementation of the second control interface 236.

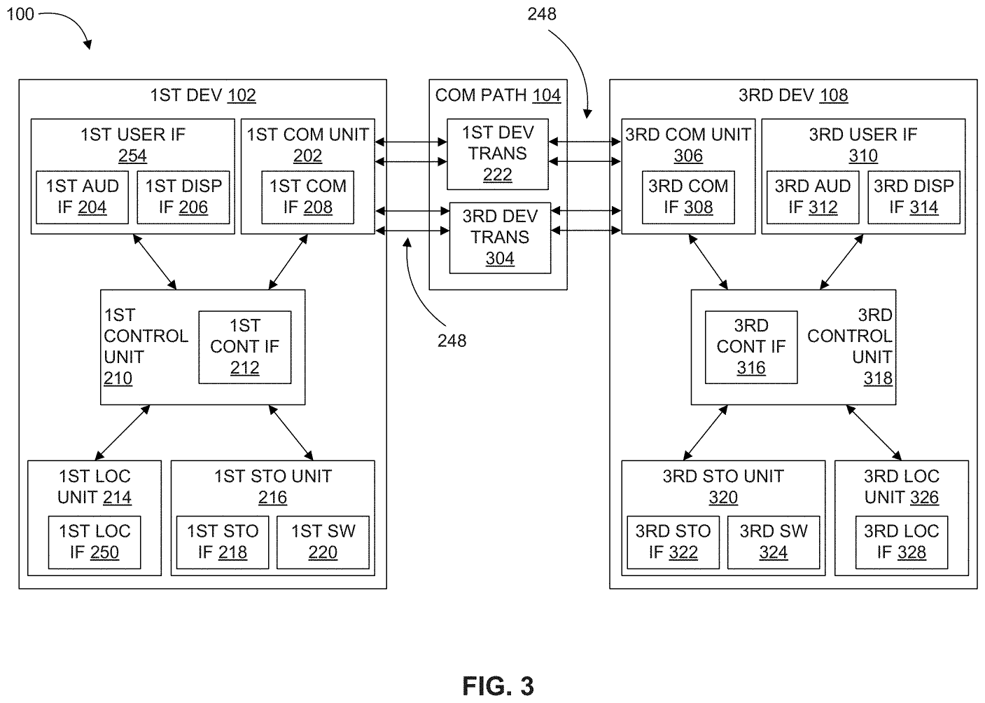

Referring now to FIG. 3, therein is shown a further example block diagram of the components of the computing system 100, according to in an embodiment of the present invention. The computing system 100 can further include the third device 108. In one embodiment, the third device 108 can be optimized for implementing an embodiment of the present invention in a multiple device embodiment with the first device 102 and the second device 106 of FIGS. 1 and 2. In one embodiment, the third device 108 can provide additional or higher performance processing power compared to the first device 102, the second device 106, or a combination thereof. The third device 108 can send information in a third device transmission 304 over the communication path 104 to the first device 102. While not shown, the third device 108 can also send information in the third device transmission 304 over the communication path 104 to the second device 106. The first device 102 can send information in a first device transmission 222 over the communication path 104 to the third device 108. The first device transmission 222 and the third device transmission 304 can be sent over the communication channels 248.

In one embodiment, the third device 108 can include components including a third control unit 318, a third storage unit 320, a third communication unit 306, a third user interface 310, and a third location unit 326. The components of the third device 108 can further include sub-components including a third communication interface 316, a third audio interface 312, a third display interface 314, a third control interface 316, a third storage interface 322, a third software 324, and a third location interface 328. In one embodiment, the components and sub-components of the third device 108 can have the same functionality and can be implemented in the same manner as the components and sub-components of the first device 102.

Functionality of the computing system 100 can be provided by the first control unit 210, the second control unit 238, the third control unit 318, or a combination thereof. For illustrative purposes, the first device 102 is shown with the partition having the first user interface 254, the first storage unit 216, the first control unit 210, the first location unit 214, and the first communication unit 202, although it is understood that the first device 102 can have a different partition. For example, the first software 220 can be partitioned differently such that some or all of its functionality can be, for example, in the first control unit 210 and the first communication unit 202. Also, the first device 102 can include other functional units not shown in FIGS. 2 and 3 for clarity.

The second device 106 of FIGS. 1 and 2 and the third device 108 can have a similar or different partition as the first device 102. The functional units in the each of devices 102, 106, and 108 can work individually and independently of the other functional units of the devices 102, 106, and 108. Additionally, each of devices 102, 106, and 108 can work individually and independently from the other devices 102, 106, and 108, as well as communication path 104.

For illustrative purposes, the computing system 100 is described by operation of the first device 102, the second device 106, and the third device 108. It is understood that the first device 102, the second device 106, and the third device 108 can operate any of the modules or units of the computing system 100.

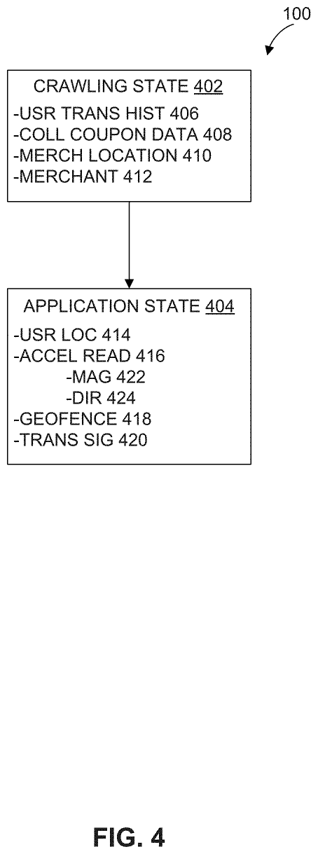

Referring now to FIG. 4, therein is shown an example control flow of operating stages of the computing system 100, according to an embodiment of the present invention. In one embodiment, the computing system 100 can operate in two stages, including a crawling state 402 and an application state 404. The embodiment shown in FIG. 4 assumes that the crawling state 402 is performed prior to the application state 404, however, this order of operation is merely exemplary and in other embodiments the crawling state 402 can be performed in parallel or in real time with the application state 404. Real time refers to an instance where the computing system 100 enables operation of the crawling state 402 at the same time or at the actual time when the computing system 100 enables operation of the application state 404.

The crawling state 402 is a mode of operation in which commands, parameters, variables, configurations, or a combination thereof of the computing system 100 are generated, identified, determined, or a combination thereof. In one embodiment, the commands, parameters, variables, or configurations that are generated, identified, or determined can be used in the application state 404. In one embodiment, the commands, parameters, variables, or configurations, can include, for example, a user transaction history 406, a collected coupon data 408, a merchant location 410, identifying information for a merchant 412, for example a merchant name, or a combination thereof.

The user transaction history 406 refers to a list, a database, a table, or a combination thereof of a user of the computing system's 100 past business transactions with a merchant 412. A merchant 412 refers to a person or company involved in provision of goods or services. For example, in one embodiment, the user transaction history 406 can include a list, a database, or a table of past purchases or past returns of items or services that the user has purchased or returned from or to the merchant 412.

The collected coupon data 408 refers to a merchant 412 related coupon information. In one embodiment, the collected coupon data 408 can include, for example, a coupon discount offer, a coupon barcode, a coupon number, a coupon QR code, a coupon expiration date, a coupon redemption location information, a merchant name, or a combination thereof. In one embodiment, the computing system 100 can generate, identify, determine, or a combination thereof the collected coupon data 408 based on the user transaction history 406.

The merchant location 410 refers to a geographic location of the merchant 412. The merchant location 410 can be represented by, for example, a navigation information in the format of (X, Y) map coordinates, where X and Y are coordinates that define the geographic location on a map. In another embodiment, the merchant location 410 can be represented by longitude and latitude information defining the geographic location of the merchant 412 on a map.

The computing system 100 can implement the crawling state 402 using the various functional units of FIGS. 1, 2 and 3 of the computing system 100, one or more external components to the computing system 100, or a combination thereof. External components refer to components external to the computing system 100. Further details of the implementation of the crawling state 402 will be discussed below.

The application state 404 is a mode of operation in which the computing system 100 can use the commands, parameters, variables, configurations, or a combination thereof that are generated, identified, or determined during the crawling state 402, to identify and activate the collected coupon data 408. In one embodiment, the identifying and activating of the collected coupon data 408 can be based on at least a user location 414. In another embodiment, the application state 404 can further identify and activate the collected coupon data 408 based on an accelerometer reading 416, a geofence 418, a transaction signal 420, or a combination thereof.

The user location 414 refers to a geographic location of a user of the computing system 100. The user location 414 can be represented by, for example, a navigation information in the format of (X, Y) map coordinates, where X and Y are coordinates that define the geographic location of the user on a map. In another embodiment, the user location 414 can be represented by longitude and latitude information defining the geographic location of the user on a map.

The accelerometer reading 416 refers to a command, parameter, variable, or signal indicating an increase in the rate or speed along a direction 424, or a change in the direction 424. In one embodiment, the accelerometer reading 416 can be generated using the first location unit 214 of FIGS. 2 and 3, the second location unit 246 of FIG. 2, the third location unit 326 of FIG. 3, or a combination thereof. The accelerometer reading 416 can include a magnitude 422 and the direction 424. The magnitude 422 of the accelerometer reading 416 refers to the rate of change in speed along the direction 424 or the rate of change in the direction 424. The magnitude 422 can be represented as a function of time and velocity, a force, or a combination thereof. For example, the accelerometer reading 416 can be denoted as meters per second squared (m/sec²) or in G-forces, such as 0.1 g, where 1 g is the gravitational force of the earth.

The direction 424 refers to a line or course along which the user, a portion of the user such as the user's appendage, or a device moves. For example, the direction 424 can be “left” or along the x-axis. In one embodiment, the direction 424 can be represented in relation to the user, the portion, or the device. The direction 424 can be from a set such as left, right, forward, back, up, and down or north-south-east-west. The direction 424 can also be from a set where negative x-axis would be equivalent to right, positive z-axis would be forward, and positive y-axis would be up. The polarity and the variable assigned to each direction can be different. For example, forward can be +y, left can be −z, and up can be +x.

The geofence 418 refers to a virtual barrier representing a location or an enclosed area associated with a binary status, action, implementation, or a combination thereof. In one embodiment, the geofence 418 can be predetermined. For example, the geofence 418 can be predetermined to encompass a certain radial distance based on the user location 414. For example, in one embodiment, the geofence 418 can be predetermined to be a certain radial distance from the user location 414, for example encompassing a two (2), five (5), or ten (10) mile radius from the user location 414. The geofence 418 can be for performing binary functions, such as sending a communication notice, enabling or disabling a feature, including identifying and activating the collected coupon data 408 based on the user location 414, a merchant location 410, the user crossing a boundary, or a combination thereof. For example, in one embodiment, the computing system 100 can identify or activate the collected coupon data 408 based on the geofence 418, such that all collected coupon data 408 associated with a merchant 412 within a two (2), five (5), or ten (10) mile radius from the user location 414 are activated. Further details regarding the activation of the collected coupon data 408 will be discussed below.

The transaction signal 420 refers to a command, parameter, variable, or signal indicating the user transacting with a merchant 412. Transacting refers to the user initiating a payment or refund from and/or to the merchant 412. The transaction signal 420 can be generated using the first device 102, the third device 108, or a combination thereof based on the first device 102, the third device 108, or a combination thereof interacting with a merchant 412. For example, the interaction can include interacting with a point of sale system, including cash register, credit card reader, payment terminal, computer, mobile device, or a combination thereof.

The computing system 100 can implement the application state 404 using the various functional units of FIGS. 1, 2 and 3 of the computing system 100, one or more external components to the computing system 100, or a combination thereof. External components refer to components external to the computing system 100. Further details of the implementation of the application state 404 will be discussed below.

The crawling state 402 and the application state 406 can further be implemented based on executing the first software 220 of FIGS. 2 and 3, the second software 244 of FIG. 2, the third software 324 of FIG. 3, or a combination thereof, or a set of instructions stored in the first storage unit 216 of FIGS. 2 and 3, the second storage unit 240 of FIG. 2, the third storage unit 320 of FIG. 3, or a combination thereof, which can be executed by the first control unit 210 of FIGS. 2 and 3, the second control unit 238 of FIG. 2, the third control unit 318 of FIG. 3, or a combination thereof. Further the crawling state 402 and the application state 406 can be implemented using the other functional units of the computing system 100 in addition to using the aforementioned functional units.

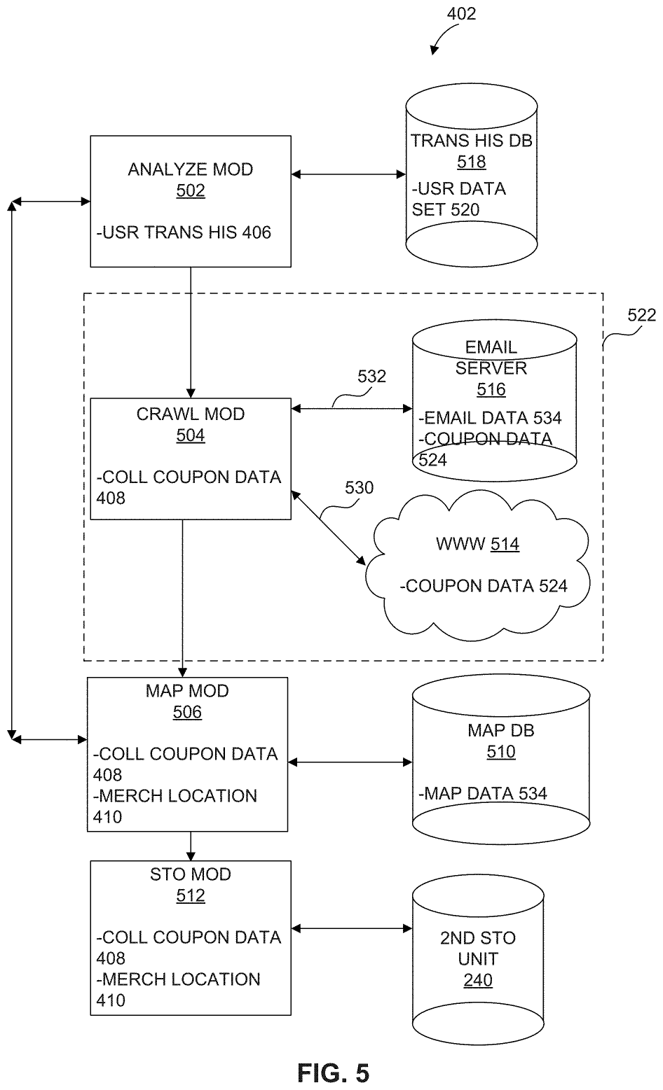

Referring now to FIG. 5, therein is shown an example control flow of a crawling state 402 of the computing system 100, according to an embodiment of the present invention. In one embodiment, the crawling state 402 can be implemented with modules and sub-modules. In one embodiment, the crawling state 402 can include an analyze module 502, a crawl module 504, a map module 506, and a storage module 512. In one embodiment, the analyze module 502 can couple to the crawl module 504 and the map module 506. The crawl module 504 can couple to the map module 506. The map module can couple to the storage module 512.

The analyze module 502 can enable the generation of the user transaction history 406. In one embodiment, the analyze module 502 can enable the generation of the user transaction history 406 by receiving a user data set 520 from a transaction history database 518 and filtering, parsing, collecting, or a combination thereof the user data set 520. The user data set 520 refers to a list, a database, a table, or a combination thereof of user related information, including account information, past purchase, past return, and transaction information of goods and services of a user with a merchant 412. In one embodiment, the user data set 520 can include, for example, a user's name, an account number, a past purchase history, a past return history, goods and services associated with the past purchase history or past return history, a statement and balance information indicating money owed or credit received from a merchant 412 based on the past purchase history or past return history, or a combination thereof.

In one embodiment, the analyze module 502 can filter, parse, or a combination thereof the user data set 520 to extract information regarding the user's past purchase history, a past return history, goods and services associated with the past purchase history or past return history, or a combination thereof. The analyze module 502 can generate the user transaction history 406 based on collecting the filtered or parsed results by, for example, compiling or generating a list, a database, a table, or a combination thereof of the filtered or parsed results to indicate the user's past purchase history, a past return history, goods and services associated with the past purchase history or past return history, or a combination thereof.

In one embodiment, the transaction history database 518 can be external to the computing system 100. The analyze module 502 can receive the user data set 520 from the transaction history database 518 through the communication path 104 and the first communication unit 202 of FIGS. 2 and 3, the second communication unit 226 of FIG. 2, the third communication unit 306 of FIG. 3, or a combination thereof.

The transaction history database 518, similar to the first storage unit 216 of FIGS. 2 and 3, the second storage unit 240 of FIG. 2, and the third storage unit 320 of FIG. 3, can be a volatile memory, a nonvolatile memory, an internal memory, an external memory, or a combination thereof. For example, the transaction history database 518 can be a nonvolatile storage such as non-volatile random access memory (NVRAM), Flash memory, disk storage, or a volatile storage such as static random access memory (SRAM) or dynamic random access memory (DRAM). In one embodiment, the transaction history database 518 can further be implemented as a database or a lookup table implemented in software, hardware, or a combination thereof.

Continuing with the example, in one embodiment, once the user transaction history 406 is generated, the analyze module 502 can pass control and the user transaction history 406 to the crawl module 504. The crawl module 504 can enable the generation of a database of the collected coupon data 408 based on the user transaction history 406 via a crawler system 522.

The crawler system 522 refers to a system that automatically and continuously searches, indexes, and returns a coupon data 524. The coupon data 524 refers to information related to a coupon associated with a merchant 412. The coupon data 524 can include coupon offers, including a discount for a particular product or service, a coupon barcode, a coupon number, a coupon QR code, a coupon expiration date, a coupon redemption location information, a merchant name associated with the coupon, or a combination thereof.

In one embodiment, the crawler system 522 can include a web crawler process 530. In another embodiment, the crawler system 522 can further include an email crawling process 532. The web crawler process 530 refers to a process that automatically and continuously searches, indexes, and returns the coupon data 524 based on following hypertext links from web page to web page on a network, such as a World Wide Web 514 via the Internet. In one embodiment, the web crawler process 530 can search for, index, and return the coupon data 524 based on the user transaction history 406. For example, in one embodiment, the web crawler process 530 can search for coupon data 524 from the merchant 412 that the user has purchased goods and services from in the past. In another embodiment, the web crawler process 530 can further search for coupon data 524 based on products and services the user has purchased in the past. In another embodiment, the web crawler process 530 can further search for coupon data 524 based on products or services the user has returned in the past.

In one embodiment, the web crawler process 530 can search for, index, and return the coupon data 524 based on extracting a text, an image, a metadata, or a combination thereof from one or more web pages that contain the coupon data 524. Such web pages can include, for example, Coupon.com™, EBATES.com™, or similar web pages. The web pages can also include the merchant 412 web pages containing coupon data 524. For example, in one embodiment, the web crawler process 530 can extract the text, the image, or the metadata from web pages containing the coupon data 524, based on implementing and recognizing characters through an optical character recognition (OCR) process on the web page, through copying text or images believed to contain the coupon data 524 from the web page, through extracting metadata and tags associated with coupon data 524 from the web page, or a combination thereof, for one or more web pages that contain coupon data 524. In this way, the web crawler process 530 can extract and return coupon data 524 to the crawl module 504. In one embodiment, the web crawler process 530 can return the extracted coupon data 524 to the crawl module 504, and based on the returned extracted coupon data 524 the crawl module 504 can generate the database of the collected coupon data 408 by, for example, collecting, combining, or a combination thereof in a database, a list, a table, or a combination thereof the returned extracted coupon data 524.

In one embodiment, the web crawler process 530 can further be implemented by having the web crawler process 530 access an application programming interface (API), for accessing a database, a table, a list, or a combination thereof that stores the coupon data 524. In one embodiment, the API can be maintained by a third party and provide access to a database, the table, the list, or a combination thereof maintained by that third party. The API can be, for example, Groupon™ API, Coupons.com™ API, or other similar APIs that can grant the computing system 100 access the coupon data 524 stored in the database, the table, the list, or a combination thereof maintained by the third party who's API is accessed. The crawl module 504 can receive the coupon data 524 via the APIs and the communication path 104. Based on the received coupon data 524, the computing system 100 can generate the collected coupon data 408 by, for example, collecting, combining, or a combination thereof in a database, a list, a table, or a combination thereof the received coupon data 524.

The email crawling process 532 refers to a process that automatically and continuously searches, indexes, and returns the coupon data 524 based on analyzing a user's email data 534. In one embodiment, the email crawling process 532 can be performed using a third party application in which the user of the computing system 100 gives access or permission to in order to crawl the user's emails. The email data 534 refers to data associated with the user's email message and the content of the user's email messages. In one embodiment, the email data 534 can be contained in an email server 516. The email server 516 refers to a computer system that sends and receives email using email protocols, such as Internet Message Access Protocol (IMAP), Post Office Protocol (POP), Simple Mail Transfer Protocol (SMTP), or similar protocols.

The email data 534 can include, for example, header fields, to/from/cc/bcc information, subject line information, text or images from the body of the email, or a combination thereof. For example, in one embodiment, the email crawling process 532 can search, index, and return, the email data 534 believed to be coupon data 524 by, for example, searching for and indexing keywords in the email data 534. For example, the email crawling process 532 can search the email data 534 for keywords such as “COUPON,” “OFFER,” a merchant name, a merchant 412 associated email address, as examples, to filter email data 534 that can potentially be coupon data 524. Once the email data 534 is filtered based on keywords, in one embodiment, the email crawling process 532 can further look for additional keywords within the filtered email data 534, such as “VALID UNTIL,” “DISCOUNT,” “PERCENT OFF,” “% OFF,” “DOLLARS OFF,” “CODE,” as examples, and extract the text or images associated the email data 534 based on the keywords, and based on implementing and recognizing characters through an optical character recognition (OCR) process on the email data 534, through copying text or images from the email data 534, or a combination thereof. In this way, the email crawling process 532 can extract text or images most likely to be coupon data 524. Once extracted, the email crawling process 532 can return the extracted email data 534 to the crawl module 504, and based on the extracted email data 534 the crawl module 504 can generate the collected coupon data 408 by, for example, collecting and combining in a database, a list, a table, or a combination thereof the extracted email data 534. For example, the crawl module 504 can combine extracted email data 534 including, for example, a coupon discount offer, a coupon barcode, a coupon number, a coupon QR code, a coupon expiration date, a coupon redemption location information, a merchant 412 associated with the coupon, or a combination thereof in a database, a list, a table, or a combination thereof. The combined extracted email data 534 can constitute the collected coupon data 408.

In another embodiment, the email crawling process 532 can work in conjunction with the web crawler process 530 to return the coupon data 524. For example, in one embodiment, the email crawling process 532 can search for and index the email data 534 for a merchant 412 based on keywords indicating a merchant name, a merchant 412 associated email addresses, or a combination thereof, and based on finding the merchant name, the merchant 412 associated email address, or a combination thereof in the email data 534, the email crawling process 532 can return the merchant name, the merchant 412 associated email addresses, or a combination thereof to the crawl module 504, which can enable the web crawler process 530 to search for coupon data 524 related to the merchant 412. The web crawler process 530 can return the extracted or returned coupon data 524 associated with the merchant 412 in a similar process as previously described, and based on the extracted or returned coupon data 524 the crawl module 504 can generate the collected coupon data 408 as previously described.

In one embodiment, once the collected coupon data 408 is generated, the crawl module 504 can pass control and the collected coupon data 408 to the map module 506. The map module 506 enables the generation of a merchant location 410 based on the collected coupon data 408. For example, the map module 506 can enable the generation of the merchant location 410 based on accessing a map database 510, containing map information, to search for the merchant location 410 associated with the collected coupon data 408. For example, if the collected coupon data 408 has coupons for a particular merchant 412, for example Target™ or Safeway™, the map module 506 can access the map database 510 to search for locations of Target™ or Safeway™ within a geographic area, and return the result as the merchant location 410. In another embodiment, if the merchant 412 has more than one location, the map database 510 can return two or more locations for a merchant 412, for example, “Safeway™ on Street A” and “Safeway™ on Street B.” In this case, the two or more location for the merchant 412 can be returned as the merchant location 410, and associated with the collected coupon data 408. In this way, the map module 506 can associate the collected coupon data 408 with one or more physical geographic locations for a merchant 412.

The map database 510 can be a computer system that contains a map data 534. The map data 534 can include, for example, data or information concerning a geographic region, points-of-interest (POIs) within the geographic region, paths or roads within the geographic region, address information, including the merchant location 410, a merchant 412 address, or a combination thereof. In one embodiment, the map database 510 can be maintained by a third party that can provide access to the map database 510 via an API. For example, the API can be Google Maps™ API, Apple™ MapKit API, or other similar APIs.

Continuing with the example, in one embodiment, the map module 506 can further use the user transaction history 406 to enable the generation of the merchant location 410. For example, in one embodiment, based on the user transaction history 406, the map module 506 can determine that the user frequents one particular location of a merchant 412, or that the user frequently shops within only a certain geographic radius or area, by, for example, determining the majority of the user's past purchases or past returns of items or services are within one particular zip code. As a result, the map module 506 can enable the generation of the merchant location 410 based on limiting the search on the map database 510 to locations of the merchant 412 within that geographic radius, area, or zip code. In this way, the map module 506 can limit the number of locations it searches for a merchant 412 and can provide further targeted search results for the user.

In one embodiment, once the merchant location 410 is generated, the map module 506 can pass control, the merchant location 408, and the collected coupon data 408 to the storage module 512. The storage module 512 can interface with the first storage unit 216 of FIGS. 2 and 3, the second storage unit 240 of FIG. 2, the third storage unit 320 of FIG. 3, or a combination thereof via the first storage interface 218, the second storage interface 242, the third storage interface 322, or a combination thereof to store the merchant location 408 and the collected coupon data 408 for retrieval in the application state 404. While in the embodiment with respect to this FIG. 5, the storage unit indicated is the second storage unit 240, this is merely an example and in other embodiments other storage units, such as the first storage unit 216 can be used to store the merchant location 408 and the collected coupon data 408.

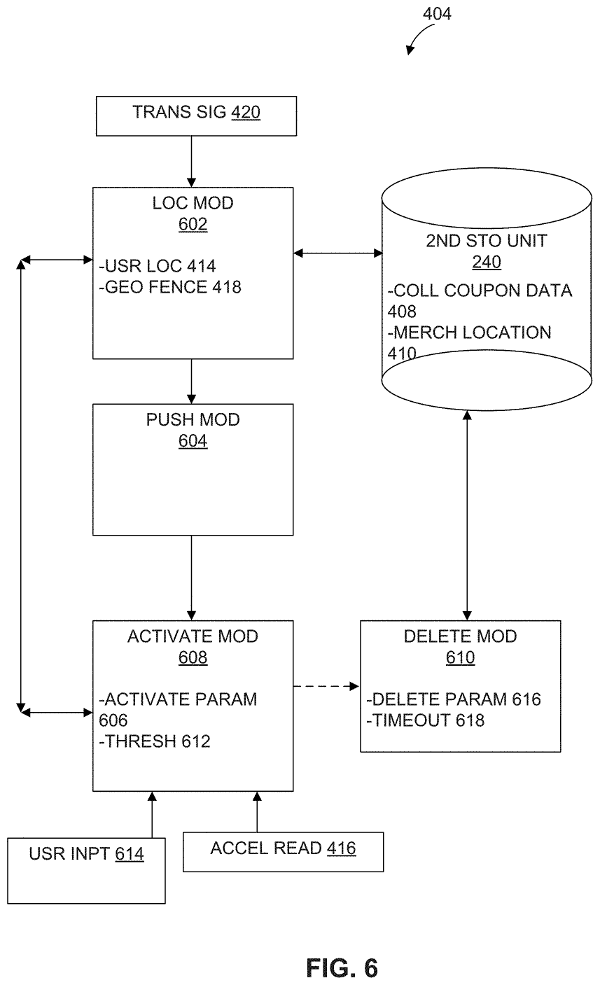

Referring now to FIG. 6, therein is shown an example control flow of an application state 404 of the computing system 100, according to an embodiment of the present invention. In one embodiment, the application state 404 can be implemented with modules and sub-modules. In one embodiment, the application state 404 can include a location module 602, a push module 604, an activate module 608, and a delete module 610. In one embodiment, the location module 602 can couple to the push module 604 and the activate module 608. The push module 604 can couple to the activate module 608. The activate module 608 can optionally couple to the delete module 610.

The location module 602 can enable the identification of the user location 414. In one embodiment, the location module 602 can enable the identification of the user location 414 based on using the first location unit 214 of FIGS. 2 and 3, the second location unit 246 of FIG. 2, the third location unit 326 of FIG. 3, or a combination thereof for a device associated with the user, for example the first device 102 or the third device 108. In one embodiment, the location module 602 can further enable the identification of the user location 414 based on accessing the map database 510 in conjunction with the first location unit 214, the second location unit 246, the third location unit 326, or a combination thereof. For the purposes of this example, it is assumed that the user is carrying the device associated with the user, such that the location unit of the device associated with the user can be used to identify the user location 414.

Continuing with the example, in one embodiment, based on identifying the user location 414, the location module 602 can further enable identifying a merchant 412, and can further enable the retrieval of the collected coupon data 408 based on identifying the merchant 412. For example, in one embodiment, if the user location 414 is identified to be at “LOCATION X,” the location module 602 can access a storage unit, for example the second storage unit 240 as shown in the embodiment of this FIG. 6, to determine whether there are any merchants 412 such that the merchant location 410 matches “LOCATION X.” If a match is found, the location module 602 can further identify the collected coupon data 408 associated with the merchant 412, and retrieve the collected coupon data 408 for further processing by the computing system 100.

In another embodiment, the location module 602 can further enable identifying a merchant 412 based on the user location 414 and a geofence 418. For example, if the user location 414 is identified to be at “LOCATION X,” the location module 602 can generate a geofence 418 based on “LOCATION X,” and can access a storage unit, for example the second storage unit 240 as shown in the embodiment of this FIG. 6, to determine whether there is a merchant 412 such that the merchant location 410 falls within the boundaries of the geofence 418. If, for example, a merchant 412 is found such that the merchant location 410 falls within the boundaries of the geofence 418, the location module 602 can determine that a match is found and the location module 602 can further identify the collected coupon data 408 for the merchant 412, and retrieve the collected coupon data 408 for further processing by the computing system 100.

In another embodiment, the location module 602 can further enable identifying a merchant 412 based on a user location 414 and a transaction signal 420. For example, in one embodiment, the user can transact with a merchant 412 using a device associated with the user, for example the first device 102, the third device 108, or a combination thereof. In one embodiment, the device associated with the user can generate the transaction signal 420 indicating that a transaction is taking place. The transaction signal 420 can further be transmitted to the location module 602 via the communication path 104 and the functional units of the first device 102, the third device 108, or a combination thereof, for example the first communication unit 202 of FIGS. 2 and 3, the third communication unit 306 of FIG. 3, or a combination thereof.

In one embodiment, when the location module 602 receives the transaction signal 420, the location module 602 can identify the merchant 412 based on the transaction signal 420, by for example, tracking the IP address of the transaction signal 420, extracting information from the transaction signal 420 indicating the address of the merchant's 412 cash register, credit card reader, payment terminal, computer, mobile device, or a combination thereof. The location module 602 can further determine that the user is at a particular location based on the transaction signal 420, for example “LOCATION X,” which the location module 602 can designate as the user location 414. Based on the user location 414, the location module 602 can access a storage unit, for example the second storage unit 240 as shown in the embodiment of this FIG. 6, to determine whether there are any merchants 412 such that the merchant location 410 matches “LOCATION X.” If a match is found, the location module 602 can further identify the collected coupon data 408 for the merchant 412, and retrieve the collected coupon data 408 for further processing by the computing system 100.

In one embodiment, once the location module 602 identifies the collected coupon data 408, the location module 602 can pass control and the collected coupon data 408 to the push module 604. The push module 604 enables the transmission of the collected coupon data 408 to a device associated with the user, for example the first device 102 or the third device 108. The push module 604 can transmit the collected coupon data 408 via the communication path 104. In one embodiment, the collected coupon data 408 can be stored on a storage unit of the device associated with the user, for example the first storage unit 216, the third storage unit 320, or a combination thereof. In one embodiment, the collected coupon data 408 can be displayed on the device associated with the user. For example, the collected coupon data 408, such as a coupon discount offer, a coupon barcode, a coupon number, a coupon QR code, a coupon expiration date, a coupon redemption location information, a merchant name, or a combination thereof can be displayed on, for example the first device 102, the third device 108, or a combination thereof. The collected coupon data 408 can be displayed using the components of the device associated with the user, for example the first user interface 254 of FIGS. 2 and 3, the third user interface 310 of FIG. 3, or a combination thereof.

In one embodiment, the collected coupon data 408 displayed on the device associated with the user can be used to redeem the coupon. For example, the coupon barcode, the coupon number, the coupon QR code, or a combination thereof can be used as part of an optical scan such that a merchant 412 point of sale system can scan the coupon barcode, the coupon number, the coupon QR code, or a combination thereof to apply the coupon to a user's transaction with the merchant 412.

In one embodiment, once the push module 602 transmits the collected coupon data 408 to the device associated with the user, the push module 604 can pass control to the activate module 608. The activate module 608 enables the activation of the collected coupon data 408. Activation refers to the process of making the collected coupon data 408 operative, such that the collected coupon data 408 can apply the discount associated with the collected coupon data 408 when a user is transacting with a merchant 412.

In one embodiment, the activate module 608 can activate the collected coupon data 408 based on generating an activate parameter 606. The activate parameter 606 refers to a parameter, command, variable, or signal that turns “on” the collected coupon data 408 such that the collected coupon data 408 can apply the discount associated with the collected coupon data 408 when a user transacts with a merchant 412. In one embodiment, the activate parameter 606 can be generated automatically based on the accelerometer reading 416, the transaction signal 420, the geofence 418, or a combination thereof. In one embodiment, the activate parameter 606 can further be generated based on a user input 614.

In one embodiment, the activate parameter 606 can be generated based on the accelerometer reading 416. For example, the activate module 608 can receive the accelerometer reading 416 from a device associated with a user, for example the first device 102, the third device 108, or a combination thereof. In one embodiment, the accelerometer reading 416 can indicate movement of the device associated with a user. In one embodiment, the activate module 608 can determine that the activate parameter 606 should be generated based on the movement being greater than a threshold value 612. For example, if a user uses the first device 102, the third device 103, or a combination thereof to conduct a transaction with a merchant 412, the first location unit 214, the third location unit 326, or a combination thereof can sense the movement of the first device 102, the third device 103, or a combination thereof because the user will, for example, take the first device 102, the third device 108, or a combination thereof out of his or her pocket, wallet, or purse and make a movement to tap, slide, or swipe the first device 102, the third device 108, or a combination thereof on or in the merchant's 412 point of sale system. In one embodiment, the movement of the first device 102, the third device 108, or a combination thereof, can be captured in the accelerometer reading 416, using the first location unit 214, the third location unit 326, or a combination thereof and transmitted to the activate module 608. Based on the accelerometer reading 416, the activate module 608 can determine whether to generate the activate parameter 606.

In one embodiment, the activate module 608 can determine whether to generate the activate parameter 606 based on the acceleration reading 416 being greater than a threshold value 612. The threshold value 612 refers to a parameter or value, that if the acceleration reading 416 is greater than, the activation parameter 606 is generated. In one embodiment, the threshold value 612 can be denoted in the same units as the accelerometer reading 416. For example, in one embodiment if the threshold value 612 is set to 3 inches per second and if the accelerometer reading 416 is greater than 3 inches per second, the activate module 608 will generate the activate parameter 606 to activate the collected coupon data 408 that was transmitted to the device that is associated with the user. Once activated, the activate module 608, can apply the collected coupon data 408 to a transaction with the merchant 412, by for example, applying the discount associated with the collected coupon data 408 at the time of transaction or enabling the merchant 412 to apply the discount associated with the collected coupon data 408 by, for example, allowing the merchant 412 to scan the collected coupon data 408 or otherwise transmitting the collected coupon data 408 to the merchant 412.

In one embodiment, the activate parameter 606 can be generated based on a transaction signal 420. For example, the activate module 608 can receive a transaction signal 420 from a device associated with a user, for example the first device 102, the third device 108, or a combination thereof. The transaction signal 420 can indicate that a transaction is taking place between a user and a merchant 412. Based on the transaction signal 420, the activate module 608 can determine that any collected coupon data 408 associated with the merchant 412 should be activated, and as a result generate the activate parameter 606. Once activated, the activate module 608, can apply the collected coupon data 408 to a transaction with the merchant 412, by for example, applying the discount associated with the collected coupon data 408 at the time of transaction or enabling the merchant 412 to apply the discount associated with the collected coupon data 408 by, for example, allowing the merchant 412 to scan the collected coupon data 408 or otherwise transmitting the collected coupon data 408 to the merchant 412.

In one embodiment, the activate parameter 606 can be generated based on a geofence 418. For example, if a device associated with the user, for example the first device 102, the third device 108, or a combination thereof is determined, using the first location unit 214, the third location unit 326, or a combination thereof and the location module 602, to have crossed into the geofence 418 boundary such that the device is within the boundary of the geofence 418, the activate module 608 can determine that any collected coupon data 408 for a merchant 412 within the geofence 418 should be activated, and as a result can generate the activate parameter 606. Once activated, the activate module 608, can apply the collected coupon data 408 to a transaction with the merchant 412, by for example, applying the discount associated with the collected coupon data 408 at the time of transaction or enabling the merchant 412 to apply the discount associated with the collected coupon data 408 by, for example, allowing the merchant 412 to scan the collected coupon data 408 or otherwise transmitting the collected coupon data 408 to the merchant 412.

In one embodiment, the activate parameter 606 can be generated based on a user input 614. The user input 614 refers to a variable, signal, parameter, command, or a combination thereof provided by the user indicating that the collected coupon data 408 should be activated. For example, in one embodiment, the device associated with the user, for example the first device 102, the third device 108, or a combination thereof, can display the collected coupon data 408 on the first display interface 206 of FIGS. 2 and 3, the third display interface 314 of FIG. 3, or a combination thereof. Based on the displayed collected coupon data 408, the user using the first user interface 254, the third user interface 310, or a combination thereof, can provide the user input 614, by for example pressing a button or swiping or pressing on the first display interface 206, third display interface 314, or a combination thereof, or typing or inputting a command indicating that the collected coupon data 408 displayed should be activated. In one embodiment, the user input 614 can be transmitted to the activate module 608, which can generate the activate parameter 606 based on the user input 614. Once activated, the activate module 608, can apply the collected coupon data 408 to a transaction with the merchant 412, by for example, applying the discount associated with the collected coupon data 408 at the time of transaction or enabling the merchant 412 to apply the discount associated with the collected coupon data 408 by, for example, allowing the merchant 412 to scan the collected coupon data 408 or otherwise transmitting the collected coupon data 408 to the merchant 412.

In one embodiment, once the activation module 608 determines whether to activate the collected coupon data 408, control can optionally pass to the delete module 610. The delete module 610 can enable the deletion of the collected coupon data 408 by generating a delete parameter 616. The delete parameter 616 refers to a signal, variable, parameter, command, or a combination thereof that indicates the collected coupon data 408 should be deleted. In one embodiment, the delete parameter 616 can be associated with a collected coupon data 408. For example, in one embodiment, once the activate module 608 activates the collected coupon data 408 and applies, or enables the application of, the collected coupon data 408, the activate module 608 can notify the delete module 610 by sending a variable, command, parameter, or signal indicating that the collected coupon data 408 has been applied. Based on the notification, the delete module 610 can generate the delete parameter 616 for the collected coupon data 408. Based on the delete parameter 616, the delete module 610 can access a storage unit where the collected coupon data 408 is stored, for example the second storage unit 240 as indicated in the embodiment in this FIG. 6, and delete the collected coupon data 408.

In another embodiment, the delete module 610 can be a standalone module. For example, the delete module 610 can generate the delete parameter 616 without any notification from any of the modules of the computing system 100. For example, in one embodiment, the delete module 610 can generate the delete parameter 616 based on a coupon timeout signal 618. The coupon timeout signal 618 refers to a variable, command, parameter, or signal indicating that the collected coupon data 408 should be deleted. In one embodiment, the coupon timeout signal 618 can be based on a coupon expiration date, such that when the coupon expiration date has past, the coupon timeout signal 618 is generated indicating that the collected coupon data 408 associated with the coupon should be deleted. For example, in one embodiment, the delete module 610 can continuously monitor the storage unit where the collected coupon data 408 is stored, for example the second storage unit 240 as indicated in the embodiment in this FIG. 6, and compare the coupon expiration dates for the collected coupon data 408 to a current date and time. In one embodiment, if the delete module 610 determines that the coupon expiration dates for the collected coupon data 408 are before the current date and time, the delete module 610 can generate the delete parameter 616 for the collected coupon data 408 and further delete the collected coupon data 408.

It has been discovered that the methods, modules, units, and components implementing the above described computing system 100 significantly improves access to coupons because the computing system 100 implements an efficient method of retrieving, storing, and applying coupons to user transactions with a merchant 412. It has been further discovered that the computing system 100 significantly improves access to coupons because it removes the burden of users having to cut or carry paper based coupons to a merchant 412 and allows users to electronically receive and apply coupons, through a device or devices associated with the user.

It has been further discovered that the computing system 100 significantly improves access to coupons because it provides an improved and novel system that automatically applies coupons for users without users actively having to apply the coupons themselves. It has been further discovered that the computing system 100 described above, significantly improves the ability to deliver relevant coupons to users because the computing system 100 can identify and generate collected coupon data 408 based on a user transaction history 406 and deliver targeted and relevant coupons to the user. It has been further discovered that the computing system 100 significantly improves the ability of users to apply coupons because it tracks and removes expired or outdated coupons without any user input.

The computing system 100 has been described with module functions or order as an example. The computing system 100 can partition the modules differently or order the modules differently. For example, the first software 220, the second software 244, the third software 324, or a combination thereof, can include the modules for the computing system 100. As a specific example, the first software 220, the second software 244, the third software 324, or a combination thereof can include the analyze module 502, the crawl module 504, the map module 506, the storage module 512, the location module 602, the push module 604, the activate module 608, the delete module 610, and associated sub-modules included therein.

The first control unit 210, the second control unit 238, the third control unit 318, or a combination thereof, can execute the first software 220, the second software 244, the third software 324, or a combination thereof, to operate the modules. For example, the first control unit 210, the second control unit 238, the third control unit 318, or a combination thereof, can execute the first software 220, the second software 244, the third software 324, or a combination thereof, to implement the analyze module 502, the crawl module 504, the map module 506, the storage module 512, the location module 602, the push module 604, the activate module 608, the delete module 610, and associated sub-modules included therein.

The modules described in this application can be implemented as instructions stored on a non-transitory computer readable medium to be executed by the first control unit 210, the second control unit 238, the third control unit 318, or a combination thereof. The non-transitory computer readable medium can include the first storage unit 216, the second storage unit 240, the third storage unit 320, or a combination thereof. The non-transitory computer readable medium can include non-volatile memory, such as a hard disk drive, non-volatile random access memory (NVRAM), solid-state storage device (SSD), compact disk (CD), digital video disk (DVD), or universal serial bus (USB) flash memory devices. The non-transitory computer readable medium can be integrated as a part of the computing system 100 or installed as a removable portion of the computing system 100.

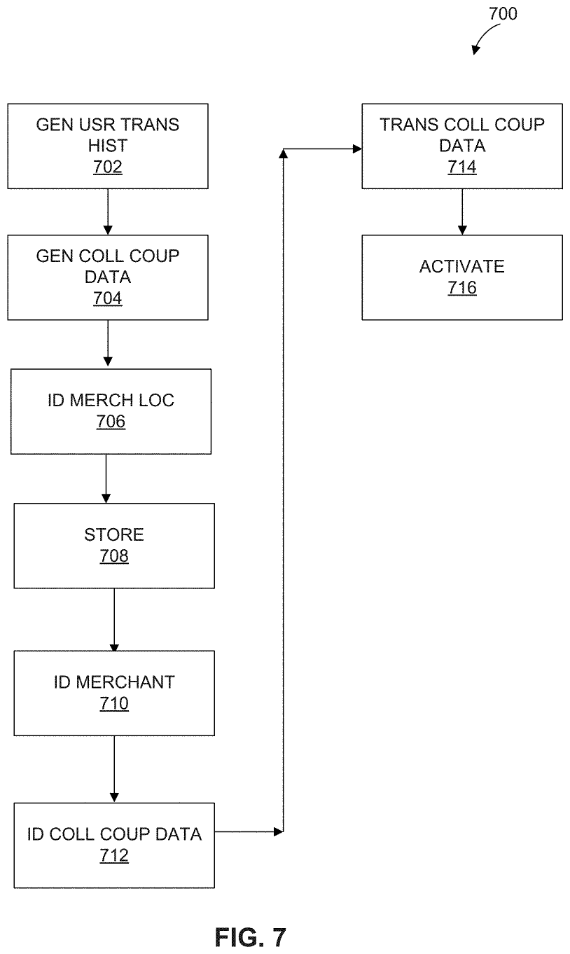

Referring now to FIG. 7, therein is shown an example method 700 of operating the computing system 100, according to an embodiment of the present invention. The method 700 includes: generating a user transaction history based on parsing a user data set received from a transaction history database as shown in box 702; generating a database of a collected coupon data based on the user transaction history as shown in box 704; identifying a merchant location based on a map data from a map database, and the database of the collected coupon data as shown in box 706; storing, in a storage unit, the database of the collected coupon data and the merchant location for retrieval during an application state as shown in box 708; identifying, in the application state, a merchant based on a user location and the merchant location as shown in box 710; retrieving, from the storage unit, the collected coupon data associated with the merchant based on identifying the merchant as shown in box 712; transmitting the collected coupon data to a transaction card for display on a user interface as shown in box 714; and activating the collected coupon data on the transaction card based on an activate parameter as shown in box 716.

The above detailed description and embodiments of the disclosed computing system 100 are not intended to be exhaustive or to limit the disclosed computing system 100 to the precise form disclosed above. While specific examples for the computing system 100 are described above for illustrative purposes, various equivalent modifications are possible within the scope of the disclosed computing system 100, as those skilled in the relevant art will recognize. For example, while processes and methods are presented in a given order, alternative implementations may perform routines having steps, or employ systems having processes or methods, in a different order, and some processes or methods may be deleted, moved, added, subdivided, combined, or modified to provide alternative or sub-combinations. Each of these processes or methods may be implemented in a variety of different ways. Also, while processes or methods are at times shown as being performed in series, these processes or blocks may instead be performed or implemented in parallel, or may be performed at different times.

The resulting method, process, apparatus, device, product, and system is cost-effective, highly versatile, and accurate, and can be implemented by adapting components for ready, efficient, and economical manufacturing, application, and utilization. Another important aspect of an embodiment of the present invention is that it valuably supports and services the historical trend of reducing costs, simplifying systems, and increasing performance.

These and other valuable aspects of the embodiments of the present invention consequently further the state of the technology to at least the next level. While the invention has been described in conjunction with a specific best mode, it is to be understood that many alternatives, modifications, and variations will be apparent to those skilled in the art in light of the descriptions herein. Accordingly, it is intended to embrace all such alternatives, modifications, and variations that fall within the scope of the included claims. All matters set forth herein or shown in the accompanying drawings are to be interpreted in an illustrative and non-limiting sense.

1. A method of operating a computing system comprising:
generating a user transaction history based on parsing a user data set received from a transaction history database;
generating a database of a collected coupon data based on the user transaction history;
identifying a merchant location based on a map data from a map database, and the database of the collected coupon data;
storing, in a storage unit, the database of the collected coupon data and the merchant location for retrieval during an application state;
identifying, in the application state, a merchant based on a user location, the merchant location, and a geofence, wherein the identifying is performed based on the merchant location being within a boundary of the geofence surrounding the user location;
retrieving, from the storage unit, the collected coupon data associated with the merchant based on identifying the merchant;
transmitting the collected coupon data to a transaction card for display on a user interface;
generating an activate parameter; and
activating the collected coupon data on the transaction card based on the activate parameter, wherein the activate parameter is activated based on identifying that the merchant is within the boundary of the geofence surrounding the user location.

2. The method as claimed in claim 1 further comprising deleting the collected coupon data based on a delete parameter.

3. The method as claimed in claim 1 further comprising generating the activate parameter based on an accelerometer reading.

4. The method as claimed in claim 1 further comprising generating the activate parameter based on a transaction signal.

5. The method as claimed in claim 1 wherein the boundary of the geofence is based on a radial distance from the user location.

6. The method as claimed in claim 1 wherein generating the database of the collected coupon data is further based on a crawler process.

7. The method as claimed in claim 1 further comprising deleting the collected coupon data based on a delete parameter, wherein the delete parameter is generated based on a coupon timeout signal.

8. A computing system comprising:
a control unit configured to:
generate a user transaction history based on parsing a user data set received from a transaction history database;
generate a database of a collected coupon data based on the user transaction history;
identify a merchant location based on a map data from a map database, and the database of the collected coupon data;
identify a merchant based on a user location, the merchant location, and a geofence, wherein the identifying is performed based on the merchant location being within a boundary of the geofence surrounding the user location;
retrieve the collected coupon data associated with the merchant based on identifying the merchant;
generate an activate parameter;
activate the collected coupon data on a transaction card based on the activate parameter, wherein the activate parameter is activated based on identifying the merchant is within the boundary of the geofence surrounding the user location; and
a storage unit, coupled to the control unit, configured to store the database of the collected coupon data and the merchant location for retrieval during an application state; and
a communication unit, coupled to the control unit, configured to transmit the collected coupon data to the transaction card for display on a user interface.

9. The system as claimed in claim 8 wherein the control unit is further configured to delete the collected coupon data based on a delete parameter.

10. The system as claimed in claim 8 wherein the control unit is further configured to generate the activate parameter based on an accelerometer reading.

11. The system as claimed in claim 8 wherein the control unit is further configured to generate the activate parameter based on a transaction signal.

12. The system as claimed in claim 8 wherein the boundary of the geofence is based on a radial distance from the user location.

13. The system as claimed in claim 8 wherein the control unit is further configured to generate the database of the collected coupon data based on a crawler process.

14. A non-transitory computer readable medium including instructions for a computing system comprising:
generating a user transaction history based on parsing a user data set received from a transaction history database;
generating a database of a collected coupon data based on the user transaction history;
identifying a merchant location based on a map data from a map database, and the database of the collected coupon data;
storing the database of the collected coupon data and the merchant location for retrieval during an application state;
identifying, in the application state, a merchant based on a user location, the merchant location, and a geofence, wherein the identifying is performed based on the merchant location being within a boundary of the geofence surrounding the user location;
retrieving the collected coupon data associated with the merchant based on identifying the merchant;
transmitting the collected coupon data to a transaction card for display on a user interface;
generating an activate parameter; and
activating the collected coupon data on the transaction card based on the activate parameter, wherein the activate parameter is activated based on identifying the merchant is within the boundary of the geofence surrounding the user location.

15. The non-transitory computer readable medium as claimed in claim 14 with instructions further comprising deleting the collected coupon data based on a delete parameter.

16. The non-transitory computer readable medium as claimed in claim 14 with instructions further comprising generating the activate parameter based on an accelerometer reading.

17. The non-transitory computer readable medium as claimed in claim 14 with instructions further comprising generating the activate parameter based on a transaction signal.

18. The non-transitory computer readable medium as claimed in claim 14 with instructions wherein the boundary of the geofence is based on a radial distance from the user location.

19. The non-transitory computer readable medium as claimed in claim 14 with instructions further comprising generating the database of the collected coupon data based on a crawler process.

20. The non-transitory computer readable medium as claimed in claim 14 with instructions further comprising deleting the collected coupon data based on a delete parameter, wherein the delete parameter is generated based on a coupon timeout signal.
